(19) United States
(12) Patent Application Publication
(10) Pub. No.: US 2023/0393051 A1
(43) Pub. Date: Dec. 7, 2023

(54) APPARATUS AND METHODS FOR AUTOMATED CORROSION TESTING

(71) Applicant: The United States of America, as represented by the Secretary of the Navy, Crane, IN (US)

(72) Inventor: Armen Kvryan, Glendale, CA (US)

(73) Assignee: The United States of America, as represented by the Secretary of the Navy, Arlington, VA (US)

(21) Appl. No.: 18/141,688

(22) Filed: May 1, 2023

Related U.S. Application Data
(60) Provisional application No. 63/336,530, filed on Apr. 29, 2022.

(51) Int. Cl. G01N 17/00; G01N 35/00

(52) U.S. Cl. CPC G01N 17/002; G01N 35/00584; G01N 2035/00346

(57) ABSTRACT

Apparatus and methods for automated corrosion testing are disclosed. The apparatus and methods afford an integrated corrosion testing system that allows input of testing parameters for testing of specimen including temperature, pH, salinity, and/or chemical composition of a testing solution (e.g., a customizable testing solution), flow rates of the solution, parameters for cyclic immersion of the specimen into the testing solution, and time of testing. The system is automated to perform corrosion testing according to the input parameter including constant monitoring of the system to ensure the parameters are met including ensuring the desired testing solution characteristics are maintained with little or no user input.

### CROSS-REFERENCE TO RELATED APPLICATIONS

The present application claims priority to U.S. Provisional Patent Application Ser. No. 63/336,530 filed Apr. 29, 2022, entitled “APPARATUS AND METHODS FOR AUTOMATED CORROSION TESTING,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 211046U502) is assigned to the United States Government and is available for licensing for commercial purposes. Licensing and technical inquiries may be directed to the Technology Transfer Office, Naval Surface Warfare Center Port Hueneme, email: alan.w.jaeger.civ@us.navy.mil.

### FIELD

The field of the present disclosure relates generally to corrosion testing systems. In particular, the disclosure relates to an automated corrosion testing system for cyclic immersion testing, which may be referred to with the acronym “ACTS” and simulates a corrosive environment that is comparable to an intended in-service environment of a specimen at test.

### BACKGROUND

Corrosion testing is used to study and understand corrosion effects of different solutions and environments on a specimen under test, and then to solve, mitigate, or prevent problems related to the studied corrosion effects. Currently, cyclic immersion testing for performing corrosion testing of a test specimen is performed either through intensive physical labor or by utilizing commercially available testers. Known immersion testing requires the physical raising and lowering of a test specimen into a solution, such as a corrosive solution. Moreover, known corrosion testing systems require manual sampling of solution temperature, pH, and flow.

### SUMMARY

Disclosed is an automated corrosion testing system (ACTS) that effects automated corrosion testing on a specimen to be tested. The system includes an automated raising and lowering system for cyclic immersion of the specimen into a test solution (e.g., a corrosive solution), as well as various subsystems for automated setting or control of the pH, temperature, and flow of the test solution. The system also includes a controller to control the automated raising and lowering system and various subsystems during testing, as well as to receive input parameters for testing of the specimen and control software to determine the control of the testing procedure based on the received parameters.

Another disclosed feature of the present disclosure is an integrated unit that provides a tank or chamber for containing the specimen and test solution, the raising/lower system for cyclically raising and lowering the specimen into the test solution, systems for controlling the temperature, pH, chemical composition, and flow of the test solution, and a controller for controlling all of the systems in a single unit. The integrated unit may also be mounted on a frame or chassis that is further movable or mobile.

Additional features and advantages of the present invention will become apparent to those skilled in the art upon consideration of the following detailed description of the illustrative embodiments that include exemplifying a best mode of carrying out the invention as presently perceived.

### BRIEF DESCRIPTION OF THE DRAWINGS

The detailed description of the drawings particularly refers to the accompanying figures.

FIG. 1 shows a trimetric view of an exemplary apparatus for corrosion testing according to aspects of the present disclosure.

FIG. 2 shows a trimetric exploded view of further exemplary plumbing features of the apparatus of FIG. 1 according to aspects of the present disclosure.

FIG. 3 shows a trimetric exploded view of an exemplary chiller and associated plumbing that may be used with the apparatus of FIG. 1 according to aspects of the present disclosure.

FIG. 4 shows a trimetric exploded view of heating elements and sensors that may be used with the apparatus of FIG. 1 according to aspects of the present disclosure.

FIG. 5 illustrates a trimetric view of an exemplary fluid filtering unit that attaches to the apparatus of FIGS. 1-4 according to aspects of the present disclosure.

FIG. 6 shows a block diagram of the system of FIG. 1 according to aspects of the present disclosure.

FIG. 7 shows a flow diagram of a methodology for performing corrosion testing using the apparatus of FIGS. 1-4 according to some aspects of the present disclosure.

### DETAILED DESCRIPTION

The embodiments of the invention described herein are not intended to be exhaustive or to limit the invention to precise forms disclosed. Rather, the examples or embodiments selected for description have been chosen to enable one skilled in the art to practice the invention.

The presently disclosed automated corrosion testing system (ACTS) provides the simulation of a corrosive environment that is comparable to an intended in-service environment of a test specimen. The disclosed ACTS automatically performs cyclic immersion testing while collecting useful data that can provide insight into the test specimen's material corrosion resistance as well as environmental degradation that might occur. Additionally, the disclosed ACTS affords an automated corrosion testing that does not require the physical raising and lowering of a test specimen into a solution, such as a corrosive solution. Furthermore, the automated data collection system removes the need for the manual sampling of temperature, pH and flow. Compared to commercially available testers, the disclosed ACTS offers a construction that is chemically resistant and allows a solution at test to be customized to match the expected operating environment of a test specimen. No commercially available testers combine all of the unique data collection features with the automated cyclic immersion testing process of the ACTS as disclosed.

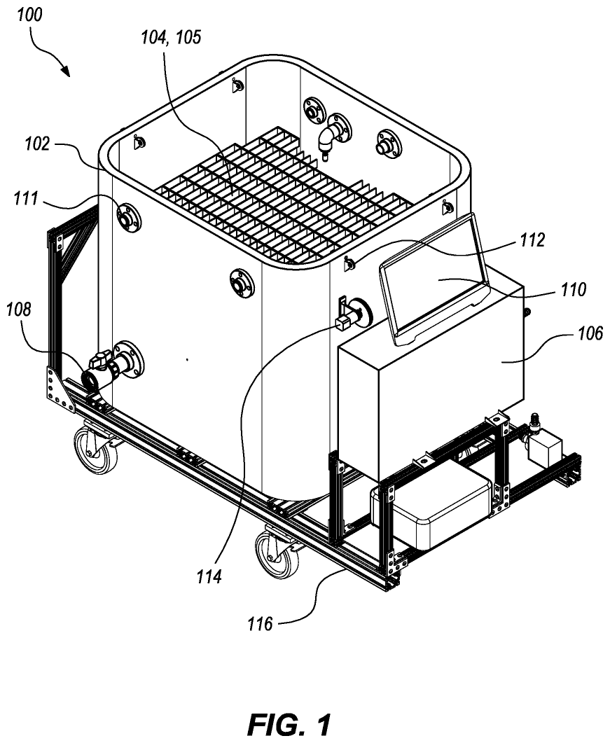

Turning to FIG. 1, this drawing illustrates a trimetric view of one example of a construction for an automated corrosion testing system 100, although the disclosure is not intended to be limiting to only this specific configuration. The system 100 includes a tank 102 for containing a corrosive testing solution, a grated tray 104 (e.g., a resin grated tray for resisting corrosion) affording a platform 105 for supporting an item under test within the tank 102, a chiller 106 and associated plumbing for chilling the testing solution, a drain 108, and a controller 110 that may include a user interface and one or more processing devices configured to receive testing parameters and control the automated operation processes of the system 100. Additionally, although not shown specifically in FIG. 1, the system 100 also includes recirculating pumps, flow arms, flow valves, heaters, temperature detectors such as resistance temperature detectors (RTDs), float switches, and various inlets or outlets in the tank 102 (e.g., 111) and overflow devices. The system may also include a pulley system (See e.g., pulley 112) and an associated motorized spooling device 114 for effecting automated raising and lowering of the grate/platform 104, 105 using cables (not shown) or equivalents and the pulleys 112. The system 100 may also include a complementary, removable tank lid (not shown) that may be placed or disposed on the open top of the tank 102 to seal the tank 102 during testing operation. The complementary tank lid affords the holding of the temperature and reduces power consumption.

In further aspects, the system 100 is configured to be able to generate any given flow pattern to mimic water currents or any movements of large bodies of water and the effects of particulate matter on a specimen (e.g., a specimen that approximates a hull of a ship, as one example). The generation of the flow patterns is achieved through a recirculating pump and at least two arms with opposing jets to create axial flow with enough power for the size/volume/scale of the machine. Additionally, the system 100 includes an integrated temperature controller to replicate various temperatures, such as seasonal temperatures for example. Also, the tank 102 and other components of the system 100 may be constructed using a chemically resistant, high-density, polyethylene (HDPE) plastic that allows for certain chemical solutions to be used as the testing solution. As will be appreciated by those skilled in the art, other chemically resistant materials may also be utilized for construction of the system.

In further aspect, the controller 110 may include a user-friendly touch-screen interface that allows technicians to run various tests according to their unique specifications. Additionally, the system 100 may include a frame or chassis 116 including wheels or casters enabling the system to be mobile or movable. This mobility may be especially useful for filling and draining operations. In one example, the frame 116 may be constructed with an 8020 aluminum frame including heavy-duty lockable casters.

In one example of operation of system 100, the tank 102 may be filled with water and salt (or other desired solution) from a mixing tank (or some other delivery source) to prepare the solution for carrying out testing. The system sensors and controller 110 may then check a desired chemical concentration, pH, or salinity of the testing solution and, in turn, further initiate adjustments of those characteristics through chemical supplies and flow valves (or equivalents used to meet out specific volumes of chemicals and the like) to introduce further chemicals used to effect the adjustments to the solution.

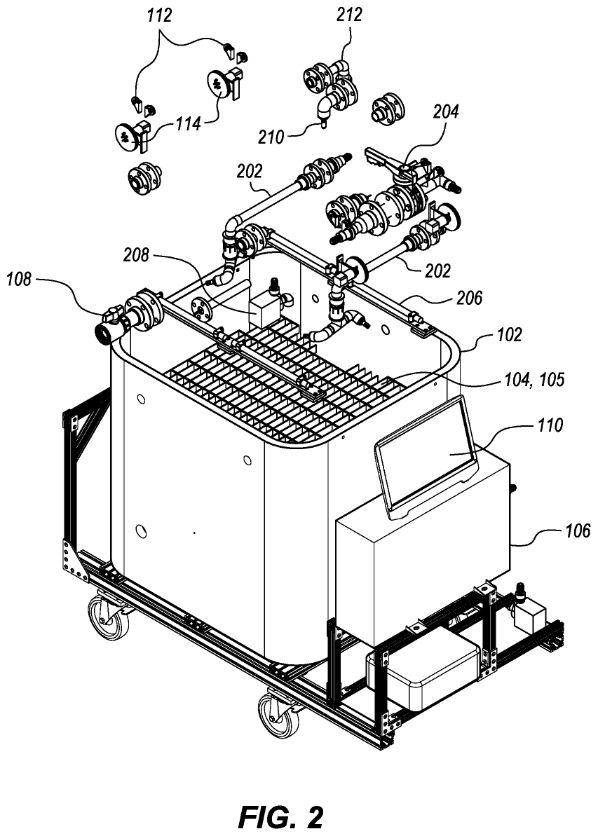

A specimen under test may then be placed on the grated tray or rack 104, 105 located inside the tank 102. Testing parameters may then be input, such as by a user via an interface that is part of controller 110, after which testing operation commences based on the input testing parameters. The solution in tank 102 may then be either heated or chilled according to the input testing parameters. Additionally, after the desired temperature is reached, stepper motors, pulleys, and cables will lower the grated tray or rack 104, 105 (and the specimen placed thereon) into the solution and a recirculating pump (e.g., 208 in FIG. 2) will power flow arms (e.g., 202 in FIG. 2) to generate an axial flow pattern of the solution. A number of on-board sensors monitors the solution level, temperature, pH, and salinity for the entire duration of the test. It is noted that in further aspects, operation may further include cyclically raising and lowering the grated tray or rack 104, 105 such that the specimen is cyclically exposed to and removed from the testing solution for a predetermined number of immersion cycles. After completion, the system 100 stops operations and raises up the grated tray or rack 104, 105 for retrieval and examination of the test specimen by a user, for example.

In yet other aspects, the controller 110 may be configured to monitor a number of data collection and monitoring devices. In one example, the system 100 may include seven or more different data collection and monitoring devices, which are monitored by the controller 110 throughout a test cycle. The controller 110 is configured to monitor various data including, but not limited to: (1) a number of immersion cycles; (2) a total time immersed; (3) a total test time; (4) a temperature of the testing solution; (5) type and/or rate of the flow of the testing solution; (6) speed and/or acceleration of the immersion (e.g., a “soft” vs. a “hard” dunk); (7) a pH of the testing solution; (8) a salinity of the testing solution; and (9) a chemical composition, concentration, or molarity of the testing solution.

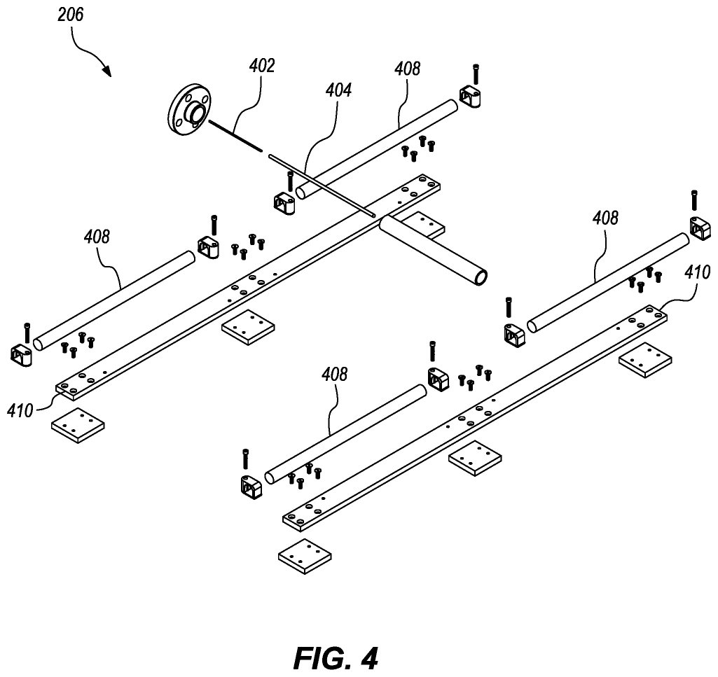

In further aspects, the apparatus or system 100 is configured with a temperature control means that may be implemented or effectuated by at least one of the chiller 106, associated plumbing associated with the chiller 106 for chilling the testing solution, heaters (e.g., heating tubes 408 in FIG. 4 as will be explained below), and temperature detection and feedback devices (e.g., 402 in FIG. 4), or equivalents thereof. The system 100 also includes a flow control means configured to create flow of the testing solution within the tank and may be effectuated or implemented by recirculating pumps, flow arms, flow valves, and associated plumbing as disclosed herein, or equivalents thereof. Moreover, apparatus or system 100 may include a raising/lowering means coupled to grate or platform 104, and configured for raising and lowering the platform and the testing specimen held thereon out of and into the testing solution according to some aspects. The raising/lowering means may be implemented by one or more of the pulley system (See e.g., pulley 112), an associated motorized spooling device 114, cables (not shown) or equivalents thereof. Yet further, the apparatus or system 100 may include a testing solution composition adjustment means configured for adjusting the composition of the testing solution. This testing solution composition adjustment means may be implemented with one or more of pumps, salinity testers, pH testers, solution composition/molarity/concentration control unit 612, salinity control unit 614, pH control unit 616, combinations thereof, or equivalents that allow customization of the testing solution as desired based on at least adjustments and/or control of solution composition/molarity/concentration, solution salinity, and solution pH via inputs from the controller 110.

FIG. 2 shows a trimetric exploded view of further exemplary plumbing features of the apparatus 100 of FIG. 1 according to aspects of the present disclosure. As illustrated, apparatus 100 may include one or more flow arms 202, a flow valve 204, heaters and temperature detector assembly 206, a recirculating pump 208 coupled to the one or more flow arms, a float switch 210 that may be configured to ensure that the tank 102 is not overfilled, and an overflow port or conduit 212 that may be coupled with the float switch 210 for diverting overflow solution out of the tank 102. The flow arms 202 may be powered by the recirculation pump 208, which, in turn, may be variably controlled by controller 110 to adjust the solution flow to match a desired condition based on inputs to the controller 110.

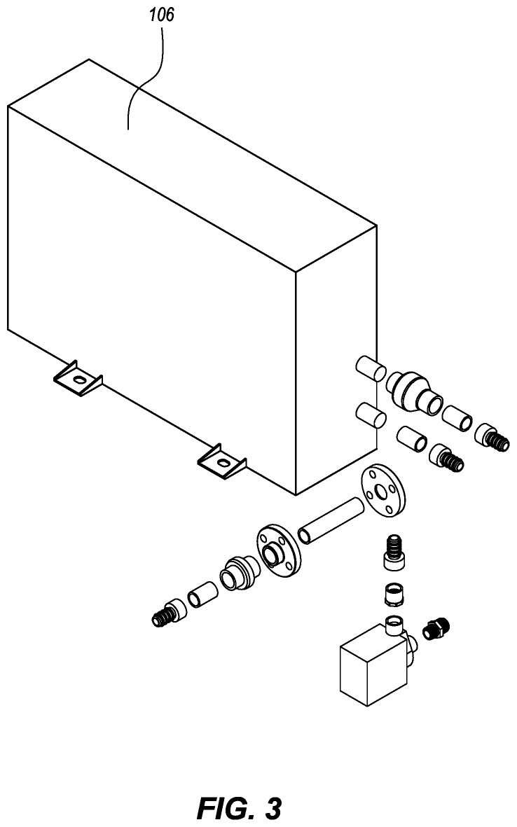

FIG. 3 shows a trimetric exploded view of an exemplary chiller 106 and associated plumbing that may be used with the apparatus of FIG. 1 according to aspects of the present disclosure. The chiller 106 is utilized to control the temperature of the solution (e.g., cool the solution to a desired temperature) within the tank 102.

FIG. 4 shows a trimetric exploded view of heating element and sensor assembly or system 206 that may be used with the apparatus of FIG. 1 according to aspects of the present disclosure. The assembly 206 may include a temperature sensor 402, such as an RTD, which may further be housed within a sheath, such as a ceramic sheath. Further, the assembly 206 may include one or more heating elements or tubes 408, which are configured to heat the testing solution in the tank 102. The heating elements or tubes 408 may be mounted to and supported by mounting bars 410, which in turn are affixed relative to the tank 102 to position and hold the elements 408 in place. The temperature sensor 402 may send temperature information to the controller 110, for example, which in turn control the heating elements 408 to raise the temperature of the testing solution to a desired temperature based on inputs to the controller 110, for example. In some aspects, the heating elements 408 may be electric, but are not limited to such source of energy for performing heating. In other aspects, the chiller 106 may also be controlled based on information from temperature sensor 206.

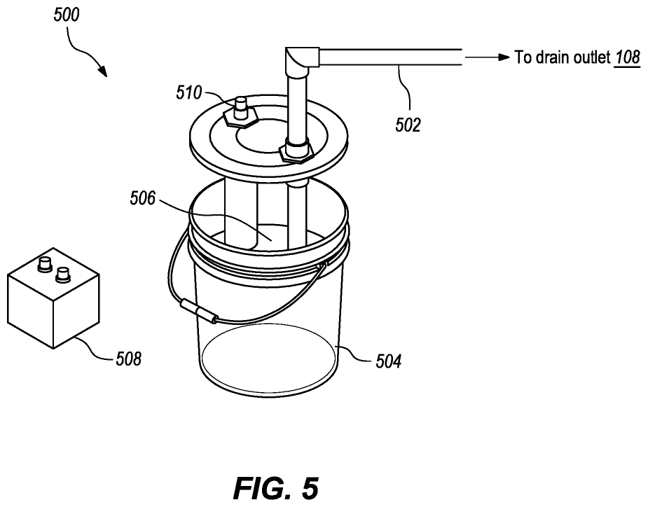

Once testing is concluded, the liquid contained within the testing unit 100 is then drained and discarded via the drain 108. Due to the nature of the testing, however, it is likely that this liquid may contain metallic particles or other materials that have been removed from the samples during the testing processes. This liquid effluent may raise issues concerning disposal due to potentially being classified as hazardous materials (e.g., HAZMAT) dependent upon relevant regulatory classifications and/or requirements. Accordingly, the apparatus 100 may further include a fluid filtering unit 500 that is coupled to the drain 108, an example of which is illustrated in FIG. 5. As shown in FIG. 5, the fluid filtering unit 500 includes an input pipe 504 coupled to the drain 108, for example, and a container tank 502. The fluid filtering unit 500 may utilize gravity along with a sieve unit 506 that is further customizable to filter whatever particulate size is desired in order to filter out the metallic particulate. Once the liquid is filtered, the remaining fluid can then be discarded with the use of a fluid filter pump 508, which may be coupled to an outlet of unit 500 such as at 510 as one example, but not limited to such.

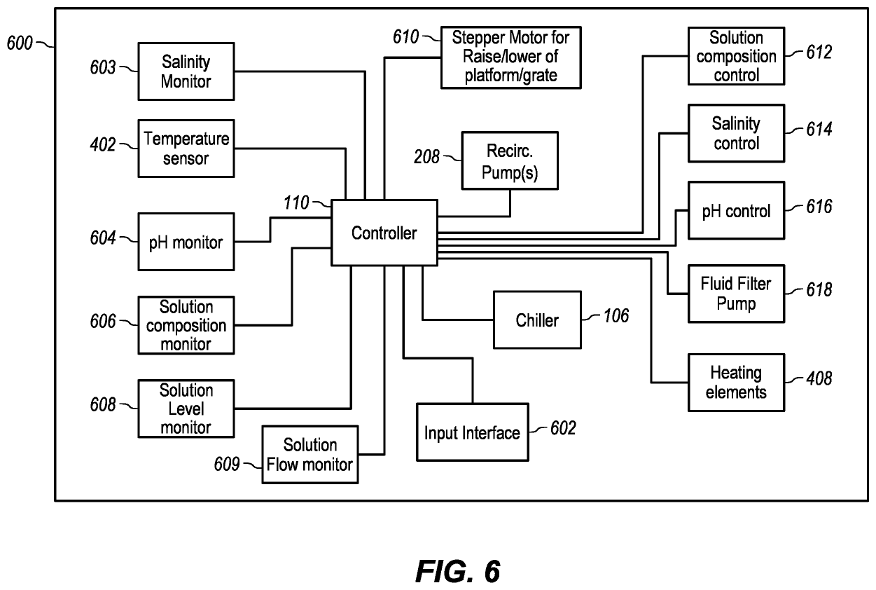

FIG. 6 shows a block diagram of the functional units of system of FIG. 1 according to aspects of the present disclosure. As illustrated, the system 600 includes the system controller 110, which may be coupled with a memory (not shown) containing or storing computer implementable instructions/code for controlling operation of the controller 110. In aspects, the controller 110 may be implemented with a general purpose processor or a specialized processor such as an application specific integrated circuit (ASIC).

The controller 110 may receive input parameters for testing from a user interface 602, which may be a touchscreen, but also may be a network interface configured to receive input testing parameters from a computer, smartphone, tablet, etc. via wired or wireless networks. Additionally, the controller 110 may be communicatively coupled with various sensors in system 100 including, but not limited to, a salinity monitor 603, temperature sensor 402, a pH monitor 604, a testing solution composition monitor 606, a solution level monitor 608, and a solution flow rate monitor 609, one or more of which enable the controller 110 to monitor and control the various parameters associated with each of these monitors.

Based on the monitored parameters, as well as based on the input parameters, the controller 110 controls various devices in the system 600 (i.e., apparatus 100) including a stepper motor 610 for raising and lowering the platform/grate 104, 105, recirculation pump 208 for controlling the testing solution flow, and chiller 106 and heating elements 408 for lowering or raising the temperature of the testing solution. The control of the stepper motor 610 may include controlling the speed and/or acceleration of the immersion (e.g., a “soft” vs. a “hard” dunk). Furthermore, the system 600 may include various devices suitable for solution composition/molarity/concentration control 612, salinity control 614, and pH control 616 that allow the system 600 to customize the testing solution as desired. Still further, the system 600 includes a fluid filter pump 618 (e.g., pump 508 shown in FIG. 5), wherein the pump 618 may be controlled by controller 110 to pump waste water from a water filter system such as system 500 in FIG. 5.

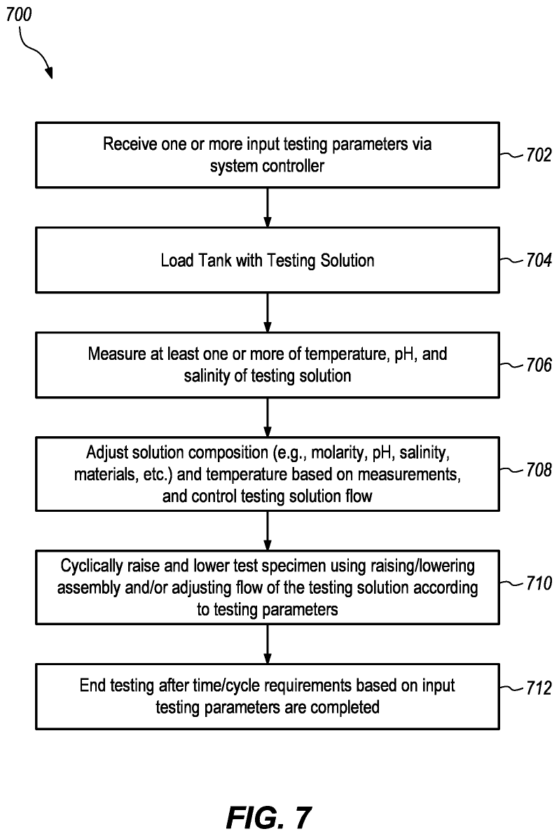

FIG. 7 shows a flow diagram of a method 700 for performing corrosion testing using the apparatus of FIGS. 1-6 according to some aspects of the present disclosure. As shown, method 700 includes receiving one or more input testing parameters via the system controller (e.g., 110) at block 702. Concurrently or after block 702, the tank 102 is loaded or filled with the testing solution at block 704, which may accomplished in conjunction with an external source or sources of liquid, salt, chemicals, etc., and receive via inlet ports or plumbing. Next, measurements may be collected of one or more of temperature, pH, and/or salinity of the testing solution as shown at block 706. At block 708, the system (e.g., the system controller 110) then adjusts the testing solution composition (e.g., adjust pH, salinity, chemical composition, etc.) and the solution temperature based on the measurements in block 708, which can be further accomplished through a feedback loop of measurement/adjustment until the desired parameters are reached. Additionally, block 708 includes adjustment of the flow of the testing solution (e.g., an axial flow or other flow), which may be effected by control of the recirculation pump 208, as one example.

Furthermore, method 700 includes cyclically raising and/lowering the test specimen out of and into the testing solution based on the input testing parameters as shown at block 710. The process 710 may be effected by controlling a stepper motor that spools a cable, for example, including controlling both distance and speed/acceleration of the motor with the controller 110. Finally, method 700 including ending testing after time or cycle requirements are met, the requirements based on the input testing parameters (or some predetermined settings) as shown at block 712. In further aspects, method 700 may include draining the testing solution from the tank 102 (via drain 108) after testing is complete to a filtering unit configured to filter the used testing solution.

As will be appreciated from the discussion above, the disclosed systems, apparatus, and methods afford numerous advantages including a chemically resistant construction that allows for a customizable testing or immersion solution or fluid, constant pH monitoring, constant Salinity monitoring, temperature regulation that includes both heating and cooling, solution flow induction (e.g., axial flow induction), and automated testing parameters that afford little or no user input (e.g., “set and go”). This automated corrosion testing device enables advanced monitoring of a cyclic immersion cycle into a customizable solution for corrosion testing to solve, mitigate, or prevent problems related to corrosion. In particular, mitigation can be accomplished by affording the ability to provide a variety of different testing methods to determine how to reduce the effects corrosion has on a particular corrosion problem. Also, prevention may be accomplished through providing the ability to test various preventative solutions and measure their effectiveness. In aspects, the disclosed tank/container and monitoring/testing devices can be used with any solution to test materials in their actual in-service environments (e.g., acidic, corrosive, electrolyte rich, oxygen rich/deprived, etc.).

As will be also appreciated by those skilled in the art, the presently disclosed corrosion testing apparatus and methods are applicable to a wide variety of industries and applications including military applications (e.g., ship building and maintenance), the oil and gas industry; the marine industry, the aerospace industry, space exploration, the automotive industry, the paint/coatings industry, the biomedical industry, and the food industry, just to name a few.

Although the present inventive concepts have been described in detail with reference to certain disclosed embodiments, variations and modifications exist within the spirit and scope of the invention as described and defined in the following claims.

1. An automated corrosion testing system comprising:
a tank and a complementary tank lid configured for holding a testing solution;
a platform disposed within the tank and configured to hold a specimen to be tested;
a temperature control apparatus including at least one of a heater or a chiller configured to adjust a temperature of the testing solution;
a flow control apparatus configured to create flow of the testing solution within the tank;
a raising/lowering apparatus coupled to the platform and configured for raising and lowering the platform and the specimen held thereon out of and into the testing solution;
a testing solution composition adjustment apparatus configured for adjusting the composition of the testing solution; and
a controller configured to receive testing parameters and control one or more of the temperature control apparatus, the flow control apparatus, the raising/lowering apparatus, and the testing solution composition adjustment apparatus based on the received testing parameters.

2. The apparatus of claim 1, further comprising:
the temperature control apparatus including at least one of one or more heating elements and a chiller configured to adjust the temperature of the testing solution.

3. The apparatus of claim 2, wherein the temperature control apparatus includes one or more temperature sensors disposed within the tanks and placed to be in contact with the testing solution, and further communicatively coupled to the controller to provide temperature measurements to the controller.

4. The apparatus of claim 3, wherein the one or more temperature sensors are each respectively housed within a ceramic sheath.

5. The apparatus of claim 3, wherein the wherein the one or more temperature sensors comprise a resistance temperature detector (RTD).

6. The apparatus of claim 1, further comprising:
the flow control apparatus including one or more recirculation pumps and associated plumbing that cause flow of the testing solution within the tank.

7. The apparatus of claim 1, further comprising:
the raising/lowering apparatus including a stepper motor, pulley assembly and associated cables coupled thereto and the platform, wherein operation of the stepper motor causes the platform to either raise or lower into the testing solution within the tank.

8. The apparatus of claim 7, wherein the raising/lowering apparatus is configured to receive control signaling from the controller to adjust the speed and/or acceleration of the platform during immersion of the specimen to be tested in the testing solution.

9. The apparatus of claim 1, further comprising:
the testing solution composition adjustment apparatus including one or more of a salinity control unit, a pH control unit, and a solution composition control unit each configured to receive respective input signals from the controller for respective control of solution salinity, solution pH, and solution composition.

10. The apparatus of claim 9, further comprising:
the testing solution composition adjustment apparatus including one or more of a salinity monitor, a pH monitor, and a solution composition monitor configured to communicate solution salinity, solution pH, and solution composition to the controller.

11. The apparatus of claim 1, further comprising:
a fluid filtering unit coupled with a drain output of the tank, and configured to filter out particulate in the solution that is drained from the drain output.

12. An automated corrosion testing system comprising:
a tank configured for holding a fluid testing solution;
a platform disposed within the tank and configured to hold a specimen to be tested;
a temperature control means including at least one of a heater or a chiller configured to adjust the temperature of the fluid testing solution;
a flow control means configured to create flow of the fluid testing solution within the tank;
a raising/lowering means coupled to the platform and configured for raising and lowering the platform and the testing specimen held thereon out of and into the fluid testing solution;
a testing solution composition adjustment means configured for adjusting the composition of the fluid testing solution; and
a controller configured to receive testing parameters and control the temperature control means, the flow control means, the raising/lowering means, and the testing solution composition adjustment means based on the received testing parameters.

13. The system of claim 12, further comprising:
the temperature control means including at least one of one or more heating elements and a chiller configured to adjust the temperature of the fluid testing solution.

14. The system of claim 13, wherein the temperature control means includes one or more temperature sensors that are each respectively housed within a ceramic sheath.

15. The system of claim 12, further comprising:
the flow control means including one or more recirculation pumps and associated plumbing that cause flow of the fluid testing solution within the tank.

16. The system of claim 12, further comprising:
the raising/lowering means including a stepper motor, pulley assembly and associated cables coupled thereto and the platform, wherein operation of the stepper motor causes the platform to either raise or lower into the fluid testing solution within the tank.

17. The system of claim 12 further comprising:
the testing solution composition adjustment means including one or more of a salinity control unit, a pH control unit, and a solution composition control unit each configured to receive respective input signals from the controller for respective control of solution salinity, solution pH, and solution composition.

18. A method for performing corrosion testing in a corrosion testing system, the method comprising:
receiving one or more input testing parameters in a system controller of the corrosion testing system;
filling a tank of the testing system with a testing solution;
measuring one or more of molarity, temperature, pH, or salinity of the testing solution;
adjusting, using the system controller, at least one of a testing solution composition and a solution temperature based on the measurements of molarity, temperature, pH, or salinity and flow of the testing solution within the tank based on the input testing parameters; and
cyclically raising and/lowering a test specimen out of and into the testing solution using platform based on the input testing parameters.

19. The method of claim 18, further comprising:
ending testing after predetermined time or cycle requirements determined by the input testing parameters.

20. The method of claim 18, wherein adjusting the testing solution composition includes controlling one or more inlet ports coupled to one or more external sources of liquid, salt, or testing solution chemicals.
